(19) United States
(12) Patent Application Publication
(10) Pub. No.: US 2008/0144002 A1
(43) Pub. Date: Jun. 19, 2008

(54) Molecularly Imprinted Polymer Sensor Device

(76) Inventors: George M. Murray, Columbia, MD (US); Glen E. Southard, Park City, UT (US)

Correspondence Address: THE JOHNS HOPKINS UNIVERSITYAPPLIED PHYSICS LABORA;OFFICE OF PATENT COUNSEL, 11100 JOHNS HOPKINS ROAD, MAIL STOP 7-156, LAUREL, MD, 20723-6099, US

(21) Appl. No.: 11/957,921

(22) Filed: Dec. 17, 2007

Related U.S. Application Data
(60) Provisional application No. 60/875,718, filed on Dec. 19, 2006.

(51) Int. Cl. G01N 1/00

(52) U.S. Cl. 356/36

(57) ABSTRACT

A molecularly imprinted polymer sensor device for detecting a specific inorganic target ion is disclosed. The device includes at least one or more molecularly imprinted polymer beads comprising a macroporous structure having a plurality of complexing cavities therein, wherein the complexing cavities contain cationic ligands spatially oriented to selectively receive and bind a specific inorganic target ion to be detected and having operatively associated therewith a light source for generating excitation energy of the beads.

### CROSS-REFERENCE TO RELATED APPLICATIONS

This application claims the benefit of prior filed co-pending U.S. Provisional Application No. 60/875,718, filed Dec. 19, 2006, and entitled “THE PREPARATION OF MOLECULARLY IMPRINTED POLYMER ION-EXCHANGE RESIN BEADS AND THEIR USE AS SEQUESTERING AGENTS FOR TOXIC OR ECONOMICALLY USEFUL IONS”, the contents of which are incorporated by reference herein.

### BACKGROUND OF THE INVENTION

1. Field of the Invention

The present invention generally relates to a molecularly imprinted polymer sensor device for measuring and detecting a wide variety of analytes, including one or more inorganic ions from a fluid such as an aqueous medium.

2. Description of the Related Art

Various levels of purity of water may be required for different end uses. Water quality may be regulated by various government agencies and trade organizations including the U.S. Environmental Protection Agency (EPA) and the Food and Drug Administration (FDA). Purified water is used in many industries including the chemical, foodstuffs, electronics, power, medical and pharmaceutical industries, as well as for human consumption. Typically, prior to use in any one of these fields, the water is treated to reduce the level of contaminants to acceptable levels. These treatment techniques include, for example, coagulation, disinfection, distillation, filtration, ion exchange, reverse osmosis, photooxidation, ozonation, and combinations thereof.

Disinfection units are typically used to reduce the concentration of viable microorganisms in a water supply. This may be accomplished by adding a disinfectant such as chlorine, ozone, hypochlorite, hypobromite or ammonia directly to the water supply so that pathogenic organisms are destroyed. Alternatively, microorganisms may be destroyed by a process, such as heating or treatment with ultraviolet light, or microorganisms may be physically removed from the water by filtration. When a chemical disinfectant is used, it is often desirable to remove the disinfectant from the water prior to consumption, and this may be accomplished in a number of ways including chemical neutralization and removal by filtration.

Filtration is used to remove suspended matter from a water supply but may also aid in the removal of dissolved or colloidal species. Filters may be structured from a variety of materials including particulate matter such as sand, diatomaceous earth, or granular activated carbon (GAC), or may be based on a membrane that may be composed of a number of different materials including polymers and fibrous materials. Filters typically work by preventing the passage of suspended material while allowing water to pass through. One way of rating a filter is by its “pore size” which provides information as to what size particle will be retained by the filter. Some methods, such as hyperfiltration, may have pore sizes small enough to exclude some dissolved species.

Water may be adversely affected by the presence of calcium or magnesium ions. Known as “hardness,” a high concentration of these cations, typically more than 200 ppm (mg/L as CaCO₃), results in a water that may leave scale or other deposits on equipment and piping. Typically, calcium and magnesium are removed from water (softened) by exchanging the calcium and magnesium ions for alternative cations, often sodium. Water softeners typically contain resin beads that exchange two sodium ions for every calcium or magnesium ion that is removed from the treated water. Periodically, the water softener may be recharged to resupply the resin beads with an adequate supply of sodium or alternative cations.

Reverse osmosis (RO) is a filtration technique that provides for the removal of dissolved species from a water supply. Typically, water is supplied to one side of an RO membrane at elevated pressure and purified water is collected from the low pressure side of the membrane. The RO membrane is structured so that water may pass through the membrane while other compounds, for example, dissolved ionic species, are retained on the high pressure side. Some species however, such as bicarbonate, may not be retained. The “concentrate” that contains an elevated concentration of ionic species may then be discharged or recycled, while the permeate, typically containing a reduced concentration of ionic species, is collected for later use.

Deionization units may also be used to remove a variety of ionic species from a water supply. Deionization units typically employ either chemical or electrical deionization to replace specific cations and anions with alternative ions. In chemical deionization, an ion exchange resin is employed to replace ions contained in the feed water. The ions on the resin are recharged by periodically passing a recharging fluid through the resin bed. This fluid may be an acid that replenishes the supply of hydrogen ions on the cation exchange resin. For anion exchange resins, the resin may be replenished by passing a base through the resin, replacing any bound anions with hydroxyl groups and preparing the resin for additional anion removal.

The available technologies require expensive equipment, large amounts of power, and are expensive to maintain. Other approaches, such as dilution with fresh water, are impractical over the long run.

U.S. Patent Application Publication No. 20070090058 (“the '058 application”) discloses a cationic molecularly imprinted polymer bead formed by complexing a target compound with a cationic ligand, polymerizing the cationic ligands to form the bead, and then extracting the target compound from the bead. The '058 application further discloses that the cationic molecularly imprinted polymer bead can have a porous structure containing a plurality of complexing cavities for selectively bind specific target compounds for removal from potable water, mine effluent, industrial effluent, or other fluids.

There remains a need for a sensor device and methods for removing contaminants from a fluid such as an aqueous medium including waste water.

### SUMMARY OF THE INVENTION

In accordance with one embodiment of the present invention, a molecularly imprinted polymer sensor device for detecting a specific inorganic target ion is provided comprising a molecularly imprinted polymer bead comprising a macroporous structure having a plurality of complexing cavities therein, wherein the complexing cavities contain cationic ligands spatially oriented to selectively receive and bind a specific inorganic target ion to be detected and having operatively associated therewith a light source for generating excitation energy for the porous structure; and a detector for detecting luminescent energy generated by the bead upon excitation.

In accordance with a second embodiment of the present invention, a molecularly imprinted polymer sensor device for detecting a specific inorganic target ion is provided comprising a housing comprising (i) an inlet and an outlet to receive a flow of fluid, (ii) a cavity comprising a plurality of molecularly imprinted polymer beads comprising a macroporous structure having a plurality of complexing cavities therein, wherein the complexing cavities contain cationic ligands spatially oriented to selectively receive and bind a specific inorganic target ion to be detected from the flow of the fluid; (iii) a light source for generating excitation energy from the beads; and (iv) a window configured to allow viewing of the luminescent energy generated by the beads from external to the housing and determine when the amount of target ions in the beads exceeds a predetermined level.

In accordance with a third embodiment of the present invention, a method for detecting a specific inorganic target ion is provided comprising contacting a fluid comprising a specific inorganic target ion to be detected with a molecularly imprinted polymer sensor device comprising a porous structure having a plurality of complexing cavities therein, wherein the complexing cavities contain cationic ligands spatially oriented to selectively receive and bind a specific inorganic target ion to be detected and having operatively associated therewith a light source for generating excitation energy for the porous structure; and detecting luminescent energy generated by the bead upon excitation.

Applicants have come to appreciate, for many analyte-detecting applications, the development of small, portable sensor devices which are relatively highly-selective and sensitive to a target analyte, and are capable of monitoring the analyte levels in real-time, is of particular interest. In certain embodiments, applicants have recognized it is further desirous for such portable sensor devices to operate using low-cost light and power sources.

### BRIEF DESCRIPTION OF THE DRAWINGS

Various embodiments are described below with reference to the drawings wherein:

FIG. 1 is a graphic illustration of the polymer matrix of the cross-linked molecularly imprinted polymer bead having a macroporous structure according to the present invention.

FIG. 2 is a schematic drawing of a sensor device according to one embodiment of the present invention.

FIG. 3 is a schematic drawing of a sensor device according to one embodiment of the present invention.

### DETAILED DESCRIPTION OF PREFERRED EMBODIMENT(S)

The present invention is directed to a sensor device that employs a molecularly imprinted polymer having a plurality of complexing containing cationic ligands spatially oriented to selectively receive and bind a specific inorganic target ion in conjunction with a light source and a detector, to detect a variety of inorganic ions with a relatively high degree of selectivity and sensitivity. The sensor device is particularly advantageous when employed in a process for removing one or more inorganic ions present in an aqueous medium, e.g., drinking water, lakes, streams, etc.

The present invention uses the techniques of molecularly imprinting polymers for providing a selective binding site in an ion exchange resin for receiving cations and anions. As used herein, the term “molecularly imprinted polymer” or “MIP” refers generally to a macroporous structure having one or more pre-organized recognition cavities which contain interactive moieties that complement the spacing of, and exhibit an affinity for, at least a portion of the binding sites on the target or imprint molecule. Specifically, the target compounds are incorporated into a pre-polymeric mixture and allowed to form bonds with the ligands. The mixture is then polymerized with the target compounds in place. Once the polymer has formed, the target compounds are removed, leaving behind cavities corresponding to the target compound. Such cavities are thus tailored for binding future target compounds giving rise to a high affinity for such compounds over other competing ions. The cavities advantageously direct the specific cation or anion to the selective binding site. The transport of ions through the device of the present invention is for separating, removing, or recovering the captured inorganic ions, which is driven by environmental and medical concerns. By employing the device in the method of the present invention, the levels of the target ions in the device can be monitored to determine when the concentration of the target ions is sufficiently high such that the device needs to be recycled.

It is worthy to note, that while specific target compounds are used to form molecularly imprinted polymers, the polymers may have a high affinity for a class of compounds that is similar to the target compound. A molecularly imprinted polymer may bind a number of compounds that are similar in shape, charge density, geometry or other physical or chemical properties.

As used herein, the term “cationic” or “cation” refers to an ion that has a positive charge. This term can refer to polymeric compounds, such as molecularly imprinted polymers, that contain a positive charge.

As used herein, the term “anionic” or “anion” refers to an ion that has a negative charge.

As used herein, the term “oxyanion” refers to an anion that contains at least one oxygen atom.

As used herein, the term “ion” refers to an atom or group of atoms chemically bonded that have a positive or negative charge. This term includes all compounds even when referred to as polyatomic ions, coordinated complexes, molecularly imprinted polymers, etc. that have a negative or positive charge.

As used herein, the term “bind,” “binding,” “bond,” “bonded,” or “bonding” refers to the physical phenomenon of chemical species being held together by attraction of atoms to each other through sharing, as well as exchanging, of electrons or protons. This term includes bond types such as: ionic, coordinate, hydrogen bonds, covalent, polar covalent, or coordinate covalent. Other terms used for bonds such as banana bonds, aromatic bonds, or metallic bonds are also included within the meaning of this term.

As used herein, “reaction” is intended to cover single step and multi-step reactions which can be direct reactions of reactants to products or may include one or more intermediate species which can be stable or transient.

Molecularly imprinted polymers (MIPs) are made by first building a complex of a target molecule and associated attached binding molecules that possess the ability to be incorporated into a polymer. The complex is usually dissolved in a larger amount of other polymerizable molecules. The bulk of the other molecules of the polymer are made with crosslinking monomers. These molecules have two places to bind to the polymer chain to form a rigid three-dimensional structure. The crosslinkers are necessary to hold the complexing molecules in place after the target molecule (also called a “template”, “analyte” or “taggant”) is removed. The target molecule to be removed in the present invention is one or more inorganic ions present in a fluid, e.g., an aqueous medium.

Representative examples of target compounds contemplated by the present method include, but are not limited to, halogens, cyanides, oxyanions of antimony, oxyanions of arsenic, oxyanions of beryllium, oxyanions of bromine, oxyanions of carbon, oxyanions of chlorine, oxyanions of chromium, oxyanions of nitrogen, oxyanions of phosphorous, oxyanions of selenium, oxyanions of sulfur, oxyanions of manganese, oxyanions of technetium, oxyanium of boron, oxyanions of vanadium, molybdenum anions, tungsten anions, and mixtures thereof. In one embodiment, the target compound can be arsenate, arsenite, nitrate, nitrite, cyanide, dicyanoaurate, or dicyanoargentate. The methods of the present invention can also be used with non-anionic classes of compounds known to those skilled in the art.

The terms “molecularly imprinted polymer” and “MIP” as used herein refer to a polymer structure that includes an ion imprinting complex. The polymer structure has organized interactive moieties complementary to the spacing of binding sites on the ion imprinting complex. Interactive moieties include functional groups or ligands. A cationic molecularly imprinted polymer bead for use in the device of the present invention can be prepared by complexing a target compound with cationic ligands, thereby forming a contaminant cationic ligand complex. In one embodiment, the complex has an octanol water partition coefficient with an absolute value from about 1 to about 10. The contaminant cationic ligand complex can then be polymerized through functional groups on the cationic ligands. The target compound can then be extracted from the cationic molecularly imprinted polymer bead. In one embodiment, the polymerizing step can further include cross-linking the polymerized ligands to achieve a more rigid structure. In another embodiment, the polymerization reaction can be a suspension polymerization. Although suspension polymerization provides a bead structure, any polymerization reaction known by those skilled in the art that provides for a substantial bead structure in situ is contemplated by the present invention.

Suitable cationic ligands include, but are not limited to, cationic oxygen containing heterocyclics, cationic nitrogen containing heterocyclics, cationic sulfur containing heterocyclics, cationic phosphorous containing heterocyclics, ammonium salts, phosphonium salts, acylinium salts, metallocenium salts, amidinium salts, imminium salts, trityl salts, or mixtures thereof. Representative examples of useful cationic ligands include 4-vinylbenzyl-N,N-dimethyl-N-decylammonium, 4-vinylbenzyl-N-decyl-N-methyl-D-glucammonium, N-methyl vinylpyridinium, or 4-vinylbenzyl-N,N-dimethyl-D-glucammonium. Other examples of useful cationic ligands are exemplified in the examples.

The number of ligands needed to form a target cationic ligand complex depends on the functionality of the ligand and the target compound. At a minimum, the ligand must be able to bind the target compound and be able to be polymerized into a cationic molecularly imprinted polymer bead. The target compound and the ligand can have multiple coordination sites capable of bonding. As one skilled in the art will readily appreciate, the ligand can be monodentate, bidentate or polydentate. A monodentate ligand can bond to only one coordination site. A bidentate ligand has the ability to bond to two separate coordination sites on a molecule simultaneously. Similarly, a polydentate ligand can simultaneously bind to multiple coordination sites. A ligand may contain more than one coordination site capable of bonding to a molecule but may nevertheless be a monodentate ligand if only one coordination site can bond to a molecule at any given moment. This may be due to stereochemistry of the ligand coordination sites.

The amount and type of ligands needed for a given cationic molecularly imprinted polymer bead will depend on the number of coordination sites available on the target compound and the associated ligands. For example, a target cationic ligand complex may contain a target compound with 4 coordination sites. This target compound could form a number of combinations with a monodentate ligand or a bidentate ligand. The target compound could then bond to 1 to 4 monodentate ligands or 1 to 2 bidentate ligands, assuming each ligand fully coordinates with the target compound. Partial coordination by the ligand and/or target compound is also contemplated. For example, the target cationic ligand complex could have 1 to 4 monodentate ligands or 1 to 4 bidentate ligands. Those skilled in the art can form multiple combinations of ligands and target compounds based on the physical and chemical properties of each and the disclosure herein. In one embodiment, a mixture of ligands can be used to bind a specific target compound.

The target cation ligand complex can be formed by a combination of ligands and target compounds that provides an overall stable complex. The methods of the present invention include target cationic ligand complexes that limit side oxidation/reduction (redox) reactions during polymerization. In one embodiment, the target cationic ligand complex has a redox potential of at least 0.3 eV versus SCE (standard calomel electrode). Additionally, the target cation ligand complex can be formed at various pH ranges. In one embodiment, the target cationic ligand complex can be formed in a pH range of about 1 to about 13. In another embodiment, the target cationic ligand complex can be polymerized in a pH range of about 5 to about 9.

A wide variety of monomers may be used for synthesizing the MIP in accordance with the principles of the present invention. Suitable non-limiting examples of monomers that can be used for preparing a MIP of the present invention include methylmethacrylate, other alkyl methacrylates, alkylacrylates, allyl or aryl acrylates and methacrylates, cyanoacrylate, styrene, methyl styrene, vinyl esters, including vinyl acetate, vinyl chloride, methyl vinyl ketone, vinylidene chloride, acrylamide, methacrylamide, acrylonitrile, methacrylonitrile, 2-acetamido acrylic acid; 2-(acetoxyacetoxy)ethyl methacrylate 1-acetoxy-1,3-butadiene; 2-acetoxy-3-butenenitrile; 4-acetoxystyrene; acrolein; acrolein diethyl acetal; acrolein dimethyl acetal; acrylamide; 2-acrylamidoglycolic acid; 2-acrylamido-2-methyl propane sulfonic acid; acrylic acid; acrylic anhydride; acrylonitrile; acryloyl chloride; (R)-acryloxy,dimethyl-g-butyrolactone; N-acryloxy succinimide-acryloxytris(hydroxymethyl)aminomethane; N-acryloyl chloride; N-acryloyl pyrrolidinone; N-acryloyl-tris(hydroxymethyl)amino methane; 2-amino ethyl methacrylate; N-(3-aminopropyl)methacrylamide; (o, m, or p)-amino-styrene; t-amyl methacrylate; 2-(1-aziridinyl)ethyl methacrylate; 4-benzyloxy-3-methoxystyrene; 2-bromoacrylic acid; 4-bromo-1-butene; 3-bromo-3,3-difluoropropane; 6-bromo-1-hexene; 3-bromo-2-methacrylonitrile; 2-(bromomethyl)acrylic acid; 8-bromo-1-octene; 5-bromo-1-pentene; cis-1-bromo-1-propene; bromostyrene; p-bromostyrene; bromotrifluoro ethylene; (±)-3-buten-2-ol; 1,3-butadiene; 1,3-butadiene-1,4-dicarboxylic acid 3-butenal diethyl acetal; 1-butene; 3-buten-2-ol; 3-butenyl chloroformate; 2-butylacrolein; t-butylacrylamide; butyl acrylate; butyl methacrylate; (o,m,p)-bromostyrene; t-butyl acrylate; (R)-carvone; (S)-carvone; (−)-carvyl acetate; cis 3-chloroacrylic acid; 2-chloroacrylonitrile; 2-chloroethyl vinyl ether; 2-chloromethyl-3-trimethylsilyl-1-propene; 3-chloro-1-butene; 3-chloro-2-chloromethyl-1-propene; 3-chloro-2-methyl propene; 2,2-bis(4-chlorophenyl)-1,1-dichloroethylene; 3-chloro-1-phenyl-1-propene; m-chlorostyrene; o-chlorostyrene; p-chlorostyrene; 1-cyanovinyl acetate; 1-cyclopropyl-1-(trimethylsiloxy)ethylene; 2,3-dichloro-1-propene; 2,6-dichlorostyrene; 1,3-dichloropropene; 2,4-diethyl-2,6-heptadienal; 1,9-decadiene; 1-decene; 1,2-dibromoethylene; 1,1-dichloro-2,2-difluoroethylene; 1,1-dichloropropene; 2,6-difluorostyrene; dihydrocarveol; (±)-dihydrocarvone; (−)-dihydrocarvyl acetate; 3,3-dimethylacrylaldehyde; N,N′-dimethylacrylamide; 3,3-dimethylacrylic acid; 3,3-dimethylacryloyl chloride; 2,3-dimethyl-1-butene; 3,3-dimethyl-1-butene; 2-dimethyl aminoethyl methacrylate; 1-(3-butenyl)-4-vinylbenzene; 2,4-dimethyl-2,6-heptadien-1-ol; 2,4-dimethyl-2,6-heptadienal; 2,5-dimethyl-1,5-hexadiene; 2,4-dimethyl-1,3-pentadiene; 2,2-dimethyl-4-pentenal; 2,4-dimethylstyrene; 2,5-dimethylstyrene; 3,4-dimethylstryene; 1-dodecene; 3,4-epoxy-1-butene; 2-ethyl acrolein; ethyl acrylate; 2-ethyl-1-butene; (±)-2-ethylhexyl acrylate; (±)-2-ethylhexyl methacrylate; 2-ethyl-2-(hydroxymethyl)-1,3-propanediol triacrylate; 2-ethyl-2-(hydroxymethyl)-1,3-propanediol trimethacrylate; ethyl methacrylate; ethyl vinyl ether; ethyl vinyl ketone; ethyl vinyl sulfone; (1-ethylvinyl)tributyl tin; m-fluorostyrene; o-fluorostyrene; p-fluorostyrene; glycol methacrylate(hydroxyethyl methacrylate); 1,6-heptadiene; 1,6-heptadienoic acid; 1,6-heptadien-4-ol; 1-heptene; 1-hexen-3-ol; 1-hexene; hexafluoropropene; 1,6-hexanediol diacrylate; 1-hexadecene; 1,5-hexadien-3,4-diol; 1,4-hexadiene; 1,5-hexadien-3-ol; 1,3,5-hexatriene; 5-hexen-1,2-diol; 5-hexen-1-ol; hydroxypropyl acrylate; 3-hydroxy-3,7,11-trimethyl-1,6,10-dodecatriene; isoamyl methacrylate; isobutyl methacrylate; isoprene; 2-isopropenylaniline; isopropenyl chloroformate; 4,4′-isopropylidene dimethacrylate; 3-isopropyl-a-a-dimethylbenzene isocyanate; isopulegol; itaconic acid; itaconalyl chloride; (±)-:linalool; linalyl acetate; p-mentha-1,8-diene; p-mentha-6,8-dien-2-ol; methyleneamino acetonitrile; methacrolein; [3-(methacryloylamino)-propyl]trimethylammonium chloride; methacrylamide; methacrylic acid; methacrylic anhydride; methacrylonitrile; methacryloyl chloride; 2-(methacryloyloxy)ethyl acetoacetate; (3-methacryloxypropyl)trimethoxy silane; 2-(methacryloxy)ethyl trimethyl ammonium methylsulfate; 2-methoxy propene(isopropenyl methyl ether); methyl-2-(bromomethyl)acrylate; 5-methyl-5-hexen-2-one; methyl methacrylate; N,N′-methylene bisacrylamide; 2-methylene glutaronitrite; 2-methylene-1,3-propanediol; 3-methyl-1,2-butadiene; 2-methyl-1-butene; 3-methyl-1-butene; 3-methyl-1-buten-1-ol; 2-methyl-1-buten-3-yne; 2-methyl-1,5-heptadiene; 2-methyl-1-heptene; 2-methyl-1-hexene; 3-methyl-1,3-pentadiene; 2-methyl-1,4-pentadiene; (±)-3-methyl-1-pentene; (±)-4-methyl-1-pentene; (±)-3-methyl-1-penten-3-ol; 2-methyl-1-pentene; -methyl styrene; t-methylstyrene; 3-methylstyrene; methyl vinyl ether; methyl vinyl ketone; methyl-2-vinyloxirane; 4-methylstyrene; methyl vinyl sulfone; 4-methyl-5-vinylthiazole; myrcene; t-nitrostyrene; 3-nitrostyrene; 1-nonadecene; 1,8-nonadiene; 1-octadecene; 1,7-octadiene; 7-octene-1,2-diol; 1-octene; 1-octen-3-ol; 1-pentadecene; 1-pentene; 1-penten-3-ol; t-2,4-pentenoic acid; 1,3-pentadiene; 1,4-pentadiene; 1,4-pentadien-3-ol; 4-penten-1-ol; 4-penten-2-ol; 4-phenyl-1-butene; phenyl vinyl sulfide; phenyl vinyl sulfonate; 2-propene-1-sulfonic acid sodium salt; phenyl vinyl sulfoxide; 1-phenyl-1-(trimethylsiloxy)ethylene; propene; safrole; styrene(vinyl benzene); 4-styrene sulfonic acid sodium salt; styrene sulfonyl chloride; 3-sulfopropyl acrylate potassium salt; 3-sulfopropyl methacrylate sodium salt; tetrachloroethylene; tetracyano ethylene; trans 3-chloroacrylic acid; 2-trifluoromethyl propene; 2-(trifluoromethyl)propenoic acid; 2,4,4′-trimethyl-1-pentene; 3,5-bis(trifluoromethyl)styrene; 2,3-bis(trimethylsiloxy)-1,3-butadiene; 1-undecene; vinyl acetate; vinyl acetic acid; 4-vinyl anisole; 9-vinyl anthracene; vinyl behenate; vinyl benzoate; vinyl benzyl acetate; vinyl benzyl alcohol; 3-vinyl benzyl chloride; 3-(vinyl benzyl)-2-chloroethyl sulfone; 4-(vinyl benzyl)-2-chloroethyl sulfone; N-(p-vinyl benzyl)-N,N′-dimethyl amine; 4-vinyl biphenyl(4-phenyl styrene); vinyl bromide; 2-vinyl butane; vinyl butyl ether; 9-vinyl carbazole; vinyl carbinol; vinyl cetyl ether; vinyl chloroacetate; vinyl chloroformate; vinyl crotanoate; vinyl cyclohexane; 4-vinyl-1-cyclohexene; 4-vinylcyclohexene dioxide; vinyl cyclopentene; vinyl dimethylchlorosilane; vinyl dimethylethoxysilane; vinyl diphenylphosphine; vinyl 2-ethyl hexanoate; vinyl 2-ethylhexyl ether; vinyl ether ketone; vinyl ethylene; vinyl ethylene iron tricarbonyl; vinyl ferrocene; vinyl formate; vinyl hexadecyl ether; vinylidene fluoride; 1-vinyl imidizole; vinyl iodide; vinyl laurate; vinyl magnesium bromide; vinyl mesitylene; vinyl 2-methoxy ethyl ether; vinyl methyl dichlorosilane; vinyl methyl ether; vinyl methyl ketone; 2-vinyl naphthalene; 5-vinyl-2-norbornene; vinyl pelargonate; vinyl phenyl acetate; vinyl phosphonic acid, bis(2-chloroethyl)ester; vinyl propionate; 4-vinyl pyridine; 2-vinyl pyridine; 1-vinyl-2-pyrrolidinone; 2-vinyl quinoline; 1-vinyl silatrane; vinyl sulfone; vinyl sulfonic acid sodium salt; o-vinyl toluene; p-vinyl toluene; vinyl triacetoxysilane; vinyl tributyl tin; vinyl trichloride; vinyl trichlorosilane; vinyl trichlorosilane(trichlorovinylsilane); vinyl triethoxysilane; vinyl triethylsilane; vinyl trifluoroacetate; vinyl trimethoxy silane; vinyl trimethyl nonylether; vinyl trimethyl silane; vinyl triphenyphosphonium bromide(triphenyl vinyl phosphonium bromide); vinyl tris-(2-methoxyethoxy)silane; vinyl 2-valerate and the like and mixtures thereof.

Acrylate-terminated or otherwise unsaturated urethanes, carbonates, and epoxies can also be used in the MIP. An example of an unsaturated carbonate is allyl diglycol carbonate. Unsaturated epoxies include, but are not limited to, glycidyl acrylate, glycidyl methacrylate, allyl glycidyl ether, and 1,2-epoxy-3-allyl propane.

Crosslinking agents that impart rigidity or structural integrity to the MIP are known to those skilled in the art. The MIP must have sufficient rigidity so that the target ion may be easily removed without affecting the integrity of the polymer. Examples of such crosslinking agents include, but are not limited to, di- tri- and tetrafunctional acrylates or methacrylates, divinylbenzene (DVB), alkylene glycol and polyalkylene glycol diacrylates and methacrylates, including ethylene glycol dimethacrylate (EGDMA) and ethylene glycol diacrylate, vinyl or allyl acrylates or methacrylates, divinylbenzene, diallyldiglycol dicarbonate, diallyl maleate, diallyl fumarate, diallyl itaconate, vinyl esters such as divinyl oxalate, divinyl malonate, diallyl succinate, triallyl isocyanurate, the dimethacrylates or diacrylates of bis-phenol A or ethoxylated bis-phenol A, methylene or polymethylene bisacrylamide or bismethacrylamide, including hexamethylene bisacrylamide or hexamethylene bismethacrylamide, di(alkene)tertiary amines, trimethylol propane triacrylate, pentaerythritol tetraacrylate, divinyl ether, divinyl sulfone, diallyl phthalate, triallyl melamine, 2-isocyanatoethyl methacrylate, 2-isocyanatoethylacrylate, 3-isocyanatopropylacrylate, 1-methy:L-2-isocyanatoethyl methacrylate, 1,1-dimethyl-2-isocyanaotoethyl acrylate, tetraethylene glycol diacrylate, tetraethylene glycol dimethacrylate, triethylene glycol diacrylate, triethylene glycol dimethacrylate, hexanediol dimethacrylate, hexanediol diacrylate, 1,3-divinyltetramethyl disiloxane; 8,13-divinyl-3,7,12,17-tetramethyl-21H,23H-porphine; 8,13-divinyl-3,7,12,17-tetramethyl-21H,23H-propionic acid; 8,13-divinyl-3,7,12,17-tetramethyl-21H,23H-propionic acid disodium salt; 3,9-divinyl-2,4,8,10-tetraoraspiro[5,5]undecane; divinyl tin dichloride and the like.

The choice of monomer and cross-linking agent will be dictated by the chemical (hydrophilicity, chemical stability, degree of cross-linking, ability to graft to other surfaces, interactions with other molecules, etc.) and physical (porosity, morphology, mechanical stability, etc.) properties desired for the polymer. The amounts of inorganic ion imprinting complex, monomer and crosslinking agents should be chosen to provide a crosslinked polymer exhibiting the desired structural integrity, porosity and hydrophilicity. The amounts can vary broadly, depending on the specific nature/reactivities of the complex, monomer and crosslinking agent chosen as well as the specific application and environment in which the polymer will ultimately be employed. The relative amounts of each reactant can be varied to achieve desired concentrations of complexes in the polymer support structure. Typically, the amount of complex will be on the order of about 0.01 mmol to about 100 mmol percent of monomer. The degree of crosslinking may, however, affect the amount of flux, i.e., a lower degree of crosslinking may provide a higher flux. The degree of cross-linking herein can range from about 5% to about 95%.

The MIPs according to the present invention can be prepared by, for example, aqueous suspension polymerization of a copolymerizable mixture of an organic phase containing matrix monomer, cross-linker, and inorganic ion imprinting complex, and an aqueous phase containing at least one or more thixotropic agents. Suitable thixotropic agents employed herein are dependent on the type and amount of monomer employed and the suspending medium. The thixotropic agents typically used in conventional suspension polymerizations are advantageously employed herein. As one skilled in the art will readily appreciate, the thixotropic agents can also advantageously act as suspension agents during the suspension polymerization process. Representative examples of such thixotropic agents include, but are not limited to, cellulose ethers such hydroxyethylcellulose, (commercially available under the trade name of “CELLOSIZE”), cross-linked polyacrylic acid known under the name of “CARBOPOL” polyvinyl alcohols known under the trade name of “RHODOVIOL”, boric acid, gums such as xanthum gum and the like and mixtures thereof. The amount of thixotropic agents can influence the size of the ion exchange resin (i.e., the use of larger amounts of thixotropic agents often results in the formation of smaller ion exchange resin particles). The amount of the thixotropic agents is generally from about 1.5 to about 5 weight percent, based on the weight of the monomers in the monomer mixture, and preferably from about 1.5 to about 2.5 weight percent, based on the weight of the monomers in the monomer mixture.

In the suspension polymerization procedure, the various phases can be thoroughly mixed separately prior to the start of the reaction and then added to the polymerization reaction vessel. While this mixing of the ingredients can be done in a vessel apart from the reaction vessel, the mixing can alternatively be conducted in the polymerization reaction vessel under an inert atmosphere, particularly where the monomers being employed are subjected to oxidation.

Polymerization proceeds at an elevated temperature, preferably above about 50° C. in the presence or absence of an initiator. Suitable initiators that can be used in the present invention include benzoyl peroxide, diacetylperoxide, and azo-bisisobutyronitrile (AIBN). The amount of initiator employed is within the range of about 0.005 to about 1.00% by weight, based on the weight of the monomer being polymerized. In the presence of an initiator, the temperature of reaction is maintained above that at which the initiator becomes active. Lower temperatures, e.g. about −30° C. to about 200° C., can be employed if high energy radiation is applied to initiate polymerization.

Proper and sufficient agitation or stirring is required throughout the polymerization in order to produce the spherical and porous beads having the desired size. Thus, the polymerization mixture is agitated to disperse the monomers in the reaction medium by shear action, thereby forming droplets. These droplets should be of such size that when transformed into polymer beads, which are spherical, and macroporous, the same will be of the desired size as discussed hereinabove. Various means are available to maintain the proper agitation. When polymerization is conducted in a reactor made of stainless steel, such reactor is preferably fitted with a rotatable shaft having one or more agitator blades. When a round-bottom flask is used as a reactor, an overhead stirrer will agitate the reaction medium. The amount of agitation necessary to obtain the desired results will vary depending upon the particular monomers being polymerized, as well as the particular polymer particle size desired. Therefore, the agitation speed such as the rpm (revolutions per minute) must be regulated within certain limits. Polymerization times can vary from about 3 hours to about 24 hours, depending on the reactivity of the monomers.

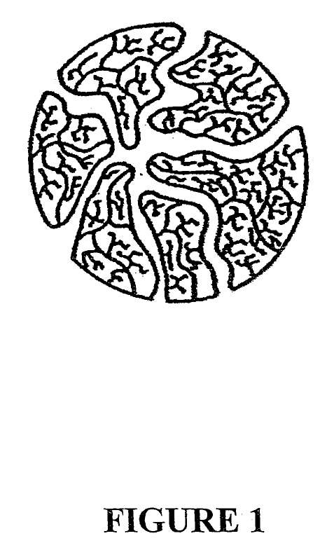

When polymerization is complete, the target ion is removed from the crosslinked polymer. Removal of the target molecule leaves a bead having a macroporous structure with complementary molecular cavities that have specific binding affinity for the target molecule. See FIG. 1. The target molecule comprising, for example, a lead cation, may be dissociated from the inorganic ion complex binding site within the polymer in a manner that does not adversely affect the imprinted cavity. In embodiments wherein the target molecule is covalently bound to the functional monomer, any appropriate method can be used to cleave the covalent bond, although the covalent bond formed should preferably be cleaved under conditions suitable to release the imprint molecule after the MIP is formed, without adversely affecting the selective binding characteristics of the MIP. To accomplish this, acetone, isopropanol, methanol or other suitable organic solvent may be used to swell the resultant polymers, allowing greater access to the coordinated metal ions because imprinted resins have a relatively low amount of functionalization and are primarily nonionic matrices. The covalent bond that is cleaved to release the imprint molecule can optionally provide an additional polar or ionic site for design and imprinting of the imprint molecule. In preferred embodiments wherein the target molecule is associated with the complex in a non-covalent manner, the non-covalently bound molecule is simply leached or washed out after polymerization.

The MIP thus obtained is in the form of macroporous beads. As used herein, the term “macroporous” refers to particles that have a permanent porous structure even in the dry state. Although the resins can swell when contacted with a solvent, swelling is not needed to allow access to the interior of the particles through the porous structure. In contrast, gel-type resins do not have a permanent porous structure in the dry state but must be swollen by a suitable solvent to allow access to the interior of the particles. In general, the beads according to the present invention may have an average particle size of from about 50 microns to about 1.5 mm and preferably from about 300 microns to about 1000 microns. In one embodiment, the beads may have an average particle size distribution in which 97% of the particles have a particle diameter greater than or equal to about 250 microns and less than or equal to about 841 microns. The average particle size of the beads may be measured by various analytical methods generally known in the art including, for example, ASTM D1921-06.

The sensor devices of the present invention contain at least one or more cationic molecularly imprinted polymer beads that can selectively remove target compounds from a fluid such as a liquid. Fluids which are suitable for use with the present invention include, but are certainly not limited to, potable water, mine effluent, mine waste, industrial effluents, settling ponds, evaporation ponds, contaminated natural bodies of water, underground water tables and the like that contains target compounds. Generally, a method includes contacting the sensor device containing the cationic molecularly imprinted polymer beads with a fluid for a sufficient amount of time that allows the fluid to penetrate the bead. After the fluid penetrates the beads, the complexing cavities contained in the beads will bind the target compound upon contact, effectively removing the target compound from the fluid.

The cationic molecularly imprinted polymer beads can be utilized in the sensor device where a plurality of the same or different beads are employed. In this manner, more than one specific ion can be removed from the fluid to provide a more efficient process. Generally, the fluid can be passed through a column or bed of the beads. Sufficient beads should be used to remove all of the undesirable inorganic ions that can be removed. If desired, the device can contain sequential cartridges with each cartridge containing a different set of beads such that selective removal of a specific target ion can be achieved with each cartridge. The fluid can then be further processed or disposed in an appropriate manner. For example, the target ions are removed from an aqueous solution, collected, and reused in another application.

According to certain embodiments, the MIP of the present invention is used in conjunction with a light source and a detector to form a sensor device for detecting a target analyte.

As used herein, the term “light” refers to optical radiation, whether ultraviolet, visible or infrared. Suitable non-limiting examples of light sources include an argon laser, blue laser, tunable laser, light emitting diode (LED), combinations of two or more thereof, and the like.

A wide range of suitable detectors can be used according to the present invention. Non-limiting examples of suitable detectors include a spectrophotometer, spectrometer (gas or mass), photomultiplier tube, monochromator equipped with a CCD camera, filters, the naked eye, combinations of two or more thereof, and the like.

In one embodiment, a sensor device of the present invention is produced by operatively associating at least one light source and, if necessary, at least one detector with an MIP. For the purposes of the present invention, two objects are considered to be “operatively associated” when connected or arranged in a manner such that excitation or luminescent energy produced by one of the objects is capable of being absorbed or detected by the other object. The light source, detector and MIP of the present invention, may be operatively associated in any manner such that excitation energy from the light source is transmitted to the MIP and absorbed by the beads, and the luminescent energy produced by the excited beads is visible or can be transmitted to, and detected by, the detector. In addition, the components of the present sensor devices may be connected or arranged with or in any suitable medium through which excitation or luminescent energy can be transmitted. Examples of suitable media include air, optical devices, such as films or fibers, and combinations of two or more thereof.

According to certain embodiments, the light source, MIP and detector are associated through optical fibers to provide a fiber optic sensor device. In certain embodiments, the fiber optic sensor device for detecting the presence of at least one analyte in a sample according to the present invention comprises: at least one optical fiber having a proximal end and a distal end for transmitting light energy, the proximal end being disposed within a probe housing, a cationic molecularly imprinted polymer bead being associated with the distal end of the optical fiber means, wherein the bead is capable of chemically binding with the analyte, a light source for generating excitation energy, the light source being operatively associated with the optical fiber such that the excitation energy passes through the optical fiber means to the MIP, and detection means operatively associated with the optical fiber means, for detecting luminescent energy generated by the bead.

The device may employ a modulated light emitting diode (LED) for excitation and a small photosensor module for detection, with the output going to a microprocessor controlled grated integrator. In addition, an optical multiplex switch may be incorporated into the design so that many sensors can be coupled to one control system, which will allow monitoring of a large area such as found in a building, subway station, shopping mall, airport, etc.

In use, a target analyte, if present, binds to the plurality of complexing containing cationic ligands in the molecularly imprinted polymer beads causing it to luminesce differently under appropriate excitation. Light from the light source means travels along the optical fiber to its distal end where it undergoes a change caused by interaction with the beads. The modified light returns along the same or another fiber to the detection means which interprets the returned light signal. Detection is based on the change that occurs in the bead's luminescence spectrum when an analyte binds to the plurality of complexing containing cationic ligands.

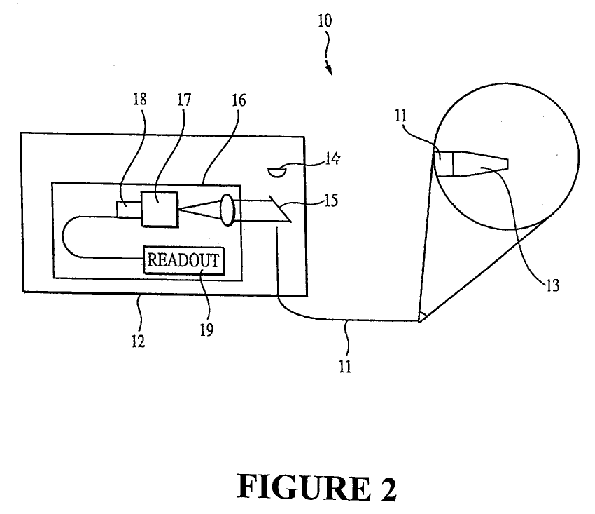

FIG. 2 illustrates an exemplary fiber optic portable sensor device according to embodiments of the present invention. The sensor device 10 in FIG. 2 comprises an optical fiber 11 having a proximal end disposed within a sensor housing 12 and a distal end of optical fiber 11 associated with a housing containing a cationic molecularly imprinted polymer bead 13. Light source 14 is a blue LED diode from which light in the blue range of the spectrum is emitted. The light is emitted through a dichroic mirror 15 to the proximal end of fiber 11 wherein the light energy is transmitted to the bead 13. Any luminescene generated by the beads travels back through fiber 11 and is reflected off the dichroic mirror 15 to detector 16 which comprises a filter 17, a photodiode 18, and a readout 19.

While the exemplary device shown in FIG. 2 comprises a single housing for the detector and light source only, any suitable combination of one or more of the light source, detector, and/or MIP beads can be housed within one or more device housings according to the present invention.

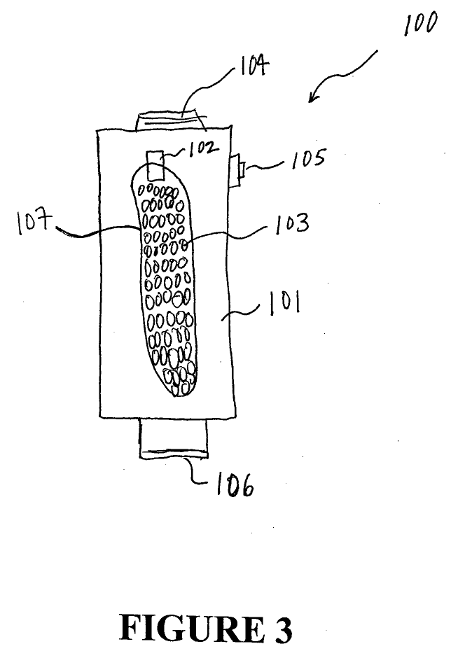

FIG. 3 illustrates an exemplary portable sensor device according to embodiments of the present invention. The sensor device 100 in FIG. 3 comprises a sensor housing 101 having an inlet (e.g., threaded adapter) 104 on one end and an outlet 106 on the other end. Sensor housing 101 further includes a cavity containing cationic molecularly imprinted polymer beads 103 which can be seen through, for example, window 107. Light source 102 is operatively connected to sensor housing 101 and having a power source 105, e.g., an on/off switch. In use, sensor device 100 can be operatively connected to, for example, a water faucet by way of inlet 104. The water is turned on and allowed to flow into sensor device 100 and pass through beads 103 such that the desired target ions can be removed and the water allowed to flow out of outlet 106 of device 100. Light source 102 such as an indicator lamp, e.g., a bulb or light emitting diode, operatively connected to housing 101 will emit light through window 107 when power source 105 is turned on. Beads 103 will illuminate in the event the amount of target ions in beads 103 exceeds a predetermined level, e.g., a blue LED will emit a blue light and once the target ions reach a predetermined level the characteristic color changes from a fluorescent blue to, for example, a fluorescent green or yellow, indicating the beads are ready for recycling. At this point, device 100 can be removed from the water faucet to, for example, wash the beads with a suitable acid to remove the target ions and the device can be reused.

While the exemplary device shown in FIG. 3 comprises a single housing for the detector and light source only, any suitable combination of one or more of the light source, detector, and/or MIP beads can be housed within one or more device housings according to the present invention.

The following examples are provided to enable one skilled in the art to practice the invention and are merely illustrative of the invention. The examples should not be read as limiting the scope of the invention as defined in the claims. All chemicals were purchased from Sigma-Aldrich Chemical Company, unless otherwise noted.

### EXAMPLE 1

Preparation of Oxyanion Imprinted Beads

### Step 1: Preparation of the Ligand N-(4-vinylbenzyl)-N-decyl-N,N-dimethyl ammonium chloride (VBzDDAC).

4-Vinylbenzyl chloride (18.60 g, 100 mmol) and N,N-dimethyl-N-decylamine (15.26 g, 100 mmol) were mixed in a 100 mL round bottomed flask. The mixture was allowed to sit overnight. The crystalline product was crushed and washed with ether. The product was collected by filtration (30.3 g, 90%)

### Step 2: Preparation of N-(4-vinylbenzyl)-N-decyl-N,N-dimethyl Arsenate (VBzDDAC)₂₋₆AsO₄.

To VBzDDAC (6.76 g, 20 mmol) of step 1 was added Na₂HAsO₄ (4.68 g, 15 mmol) in a mixture of 1-butanol (40 mL) and 150 mL H₂O containing chloranil (0.05 g, 0.2 mmol). The reaction was stirred overnight, the organic phase was separated and the solvent was removed by vacuum. The residue was suspended in ether, filtered, and then the ether was removed to give 5 g of the product.

### Step 3: Preparation of Oxyanion Beads

The aqueous phase was prepared by adding polyvinyl alcohol (14 g, 98-99% hydrolyzed, M_{W} of 85-146K, Aldrich Chemical Company) in 700 mL distilled water. The solution was boiled gently for 1 hour and after cooling a solution of boric acid (6 g in 175 mL of H₂O) was added. A measured volume of this mixture (225 mL) was then added to a 2 L suspension polymerization reactor. AIBN (0.250 g) was added and the mixture was purged with Argon for 10 minutes. An organic phase containing divinylbenzene (6.125 g), styrene (18.875 g), 2-ethylhexanol (8 mL) and (VBzDDAC)₂₋₆AsO₄ (0.400 g) of step 2 was added to the aqueous phase. The organic phase was suspended as droplets by stirring at 320 rpm. The mixture was purged with argon and heated to 80° C. for 5 hours to obtain 25% crosslinked polymer beads. The resulting polymer beads (20.44 g) were collected by filtration. The beads had a particle size distribution in which 97 percent of the beads had a particle diameter greater than or equal to 250 microns and less than or equal to 841 microns.

### EXAMPLE 2

N-(4-Vinylbenzyl)-N-decyl-N-methylglucammonium iodide: N-(4-vinylbenzyl)-N-methylglucamine (3 g, 9.6 mmol) was dissolved in dimethylformamide (DMF) (10 mL) and iodododecane (4 g, 15 mmol) was added. The solution was heated to 60° C. for 24 hours before a second addition of 1-iodododecane (1 g, 3.75 mmol). The solution was allowed to stir for an additional 16 hours before cooling to room temperature and removing the DMF. The residue was taken up into chloroform and the solution was precipitated into hexanes twice. Filtration gave 5.25 g (91% yield) of a gummy yellow product. .sup.1H-NMR (90 MHz, CDCl₃, Δ): 7.32-7.14 (dd, 4H); 6.79-6.50 (dd, 1H); 5.75-5.56(d, 1H); 5.23-5.10 (d, 1H); 4.92 (s, 2H); 3.51.

### EXAMPLE 3

3-Bromo-N-Dodecylpyridinum Iodide: 3-Bromopyridine (7.90 g, 50 mmol) was dissolved in iodododecane (14.80 g, 50 mmol) and the solution was heated to 110° C. for 80 minutes. The solution turned brown and upon cooling gave a yellow-solid. The yield was quantitative. ¹H-NMR (90 MHz, CDCl₃, δ): 9.95 (s, 1H); 9.59-9.51 (d, 1H); 8.78-8.70 (dd 1H); 8.31-8.14 (dd, 1H); 5.10-4.95 (t, 2H); 2.14-2.01 (p, 2H); 1.25 (bs, 20H); 0.93-0.81 (t, 3H).

### EXAMPLE 4

3-Vinyl-N-Dodecylpyridinum Iodide: 3-Vinyl-N-dodecylpyridinum iodide (4.54 g, 10 mmol), potassium vinyltrifluoroborate (1.34 g, 10 mmol), cesium carbonate (10.5 g, 30 mmol), Pddppf (0.65 g, 0.8 mmol) were added to a binary solvent system of THF (50 mL) and water (16 mL). The solution was heated to reflux for 18 hours before being cooled followed by addition of water. The solution was washed with ether (3×100 mL) and the organic phase was washed with 1N HCl (50 mL) and brine (2×100 mL). The solvent was removed by vacuum to give a dark brown solid (3 g, 75% yield). ¹H-NMR (90 MHz, CDCl₃, δ): 9.61 (s, 1H); 9.16 (d, 1H); 8.43 (dd 1H); 8.11 (dd, 1H); 6.86-6.83 (dd, 1H); 6.41-6.21 (d); 5.83-5.70 (d); 4.96 (b) 2.05 (b); 1.24 (bs); 0.87 (t).

### EXAMPLE 5

4-Vinyl-N-Methylpyridinum Iodide: 4-Vinylpyridine (5.26 g, 50 mmol) was dissolved in ether (30 mL) and iodomethane (7.81 g, 55 mmol) was added dropwise in one minute. The solution was stirred and immediately a yellow precipitate began to form. The reaction was allowed to continue until the solution was too thick to stir whereupon the mixture was filtered to give a yellow solid, which was washed with additional ether and air dried. Roughly 5.5 g (42% yield) of product was collected. ¹H-NMR (90 MHz, CDCl₃, δ): 9.25 (d, 2H); 8.04 (d, 2H); 9.95-6.75 (dd, 1H); 6.48-6.28 (d, 1H); 6.03-5.92 (d, 1H); 4.65 (s, 3H).

### EXAMPLE 6

N-(4-Vinylbenzyl)-N-Methylglucamine: N-Methylglucamine (9.76 g, 50 mmol) was dissolved in hot methanol (200 mL), whereupon 4-vinylbenzylchloride (7.63 g, 50 mmol) and sodium carbonate (6 g) were added to the reaction. The mixture was allowed to reflux overnight. The solution was filtered, the methanol was removed, the residue taken up in hot chloroform and filtered. A precipitate formed in the eluent, which was heated until all solids dissolved and the solution was allowed to cool to 4° C. Filtration gave 14 g (90% yield) of white powder.

¹H-NMR (90 MHz, DMSO-d₆, Δ): 7.33-7.28 (d, 4H); 6.86-6.83 (dd, 1H); 5.85-5.64 (d, 1H); 5.25-5.12 (d, 1H); 2.11 (s, 3h).

### EXAMPLE 7

N-(4-vinylbenzyl)-N-decyl-N,N-dimethylammonium chloride: Dimethyl decyl amine (9.30 g, 50 mmol) and 4-vinylbenzylchloride (7.63 g, 50 mmol) were added to ether (20 mL) and were allowed to stir for 12 hours. A yellow solid precipitated and it was collected by filtration resulting in 3 g (17% yield). The ether was removed and the remaining solution was allowed to react neat for 24 hours giving a near quantitative yield after washing with ether. ¹H-NMR (90 MHz, CDCl₃, δ): 7.68-7.38 (dd, 4H); 6.87-6.56 (dd, 1H); 5.89-5.70 (d, 1H); 5.41-5.29 (d, 1H); 5.09 (s, 2H); 3.51 (bs, 2H); 3.31 (s. 6H); 1.81 (bs, 2H) 1.25 (bs, 14H); 0.92-0.81 (t, 3H).

### EXAMPLE 8

N-(4-vinylbenzyl)-N-decyl-N,N-dimethylammonium arsenate: N-(4-Vinylbenzyl)-N-decyl-N,N-dimethylammonium chloride (6.94 g, 20 mmol) was dissolved in 2-ethyl hexanol (35 mL), disodium hydrogen arsenate (3.12 g, 10 mmol) was dissolved in water (10 mL), and the two solution were added together and mixed at high speed for 24 hours. The binary solution was allowed to separate, the organic layer was isolated and the solvent removed. The residue was taken up in ether, filtered, and the ether removed giving 2.75 g (25% yield) of a waxy product. An inhibitor (BHT or hydroquinone at 0.5 weight %) was needed when isolating and storing the arsenate complex. ¹H-NMR (90 MHz, CDCl₃, δ): 7.58-7.34 (dd, 4H); 6.79-6.47(dd, 1H); 5.80-5.61 (d, 1H); 5.32-5.20 (d, 1H); 4.88 (s, 2H); 3.51 (bs, 2H); 3.18 (s. 6H); 1.46 (bs, 2H) 1.24 (bs, 14H); 0.92-0.81 (t, 3H).

### EXAMPLE 9

N-(4-vinylbenzyl)-N-(2-hydroxyethyl)piperidinium chloride: 4-Vinylbenzylchloride (7.63 g, 50 mmol) and N-(2-hydroxyethyl)piperidine (6.46 g, 50 mmol) were mixed at room temperature for 5 hours. ¹H-NMR (90 MHz, CDCl₃, δ): 7.71-7.36 (dd, 4H); 6.86-6.54 (dd, 1H); 6.14 (bs, 1H); 5.87-5.68 (d, 1H); 5.39-5.27 (d, 1H); 5.03 (s, 2H); 4.21 (bt, 2H); 3.67-3.47 (t, 6H); 1.87 (bs, 6H).

### EXAMPLE 10

N-(4-vinylbenzyl)-N-decyl-N,N-dimethylammonium dicyanoaurate: A first solution was prepared by dissolving N-(4-Vinylbenzyl)-N-decyl-N,N-dimethylammonium chloride (2.95 g, 8.7 mmol) in water (20 mL). A second solution was prepared by dissolving potassium dicyanoaurate (2.50 g, 8.7 mmol) in water (20 mL). The two solutions were added together and mixed at high speed for 10 minutes. A white precipitate immediately formed, which slowly condensed as an oil at the bottom of the reactions flask. The oil was isolated by liquid/liquid extraction of the reaction mixture with methyl isobutyl ketone and removal of the solvent gave a waxy product (4.69 g, 98% yield) upon storing at −20° C. An inhibitor (chloranil at 0.1 weight %) was used when isolating and storing the arsenate complex. ¹H-NMR (90 MHz, CDCl₃, δ): 7.46 (s, 4H); 6.85-6.54(dd, 1H); 5.89-5.69 (d, 1H); 5.41-5.28 (d, 1H); 4.51 (s, 2H); 3.40-3.22 (bt, 2H); 3.03(s. 6H); 1.80 (bs, 2H) 1.24 (bs, 14H); 0.91-0.77 (t, 3H). ¹³C-NMR (22.5 MHz, CDCl₃, δ): 140.21; 135.19; 132.90; 126.99; 125.33; 116.49; 49.73; 31.60; 29.16. (KBr, cm⁻¹): ν=2139 (CN).

### EXAMPLE 11

Gold Bead Preparation, 25% crosslinked, 4% N-(4-vinylbenzyl)-N-decyl-N,N-dimethylammonium dicyanoaurate: An organic phase was prepared by passing styrene (17.5 g, 168 mmol), and divinylbenzene (6.25 g, 48 mmol) were passed through alumina to remove inhibitor. A suspension polymerization solution was prepared by mixing toluene (22 mL), N-(4-vinylbenzyl)-N-decyl-N,N-dimethylammonium dicyanoaurate of Example 10 (1.00, 1.8 mmol), 2-ethyl-1-hexanol (3 mL), 1-dodecanethiol (1.25 g, 6.2 mmol) and AIBN (0.250 g, 1.5 mmol). The organic phase was added to the suspension polymerization solution 1 (450 mL) in a 1000 mL reaction bottom fitted with a reaction top and mechanical stirrer. Nitrogen was bubbled through the solution for 10 minutes before heating to 80° C. for 5 hours, while stirring at 300 rpm with a pivot paddle (shaft length 50 cm; 0.7 cm diameter; impeller is 5.0 cm wide). Upon completion of the polymerization, the mixture was diluted with water (550 mL) and allowed to cool. The supernatant was decanted (100 mL reserved for ICP-OES analysis) and the beads were diluted and decanted two more times with water (600 mL). The beads were filtered, washed with water (250 mL), methanol (250 mL), acetone (250 mL), and ether (250 mL). The beads were vacuum dried for at least 4 hours.

### EXAMPLE 12

Copper (II) Bead Preparation, 25% crosslinked, 1% Copper bis(vinylthenoyltrifluoroacetonate): An organic phase was prepared by passing styrene (18.0 g, 173 mmol), and divinylbenzene (6.25 g, 48 mmol) through alumina to remove inhibitor. A suspension polymerization solution was prepared by mixing toluene (25 mL), copper bis(vinylthenoyltrifluoroacetonate) prepared as published in Synthesis of Vinyl-Substituted β-Diketones for Polymerizable Metal Complexes, Southard et al., J. Org. Chem. 2005, 70(22), 9036-9039 (0.25, 0.4 mmol), 1-dodecanethiol (1.25 g, 6.2 mmol) and AIBN (0.250 g, 1.5 mmol). The organic phase was added to the suspension polymerization solution 2 (450 mL) in a 1000 mL reaction bottom fitted with a reaction top and mechanical stirrer. Nitrogen was bubbled through the solution for 10 minutes before heating to 80° C. for 5 hours, while stirring at 300 rpm with a pivot paddle (shaft length 50 cm; 0.7 cm diameter; impeller is 5.0 cm wide). Upon completion of the polymerization, the mixture was diluted with water (550 mL) and allowed to cool. The supernatant was decanted (100 mL reserved for ICP-OES analysis) and the beads were diluted and decant two more times with water (600 mL). The beads were filtered, washed with water (250 mL), methanol (250 mL), acetone (250 mL), and ether (250 mL). The beads were vacuum dried for at least 4 hours.

### EXAMPLE 13

Typical arsenate bead preparation by reverse phase suspension polymerization, 10% crosslinked, 1% ligand/arsenate complex: N,N-dimethylacrylamide (22 g, 222 mmol) was passed through activated alumina to remove inhibitor. N,N′-methylenebisacrylamide (2.50 g, 16 mmol), bis-(N-(4-vinylbenzyl)-N-(2-hydroxyethyl)piperidinium)hydrogenarsenate (0.25 g, 0.28 mmol), and Wako VA-061 (2,2′-Azobis[2-(2-imidazolin-2-yl)propane] available from Wako Pure Chemical Company) (0.025 g, 0.1 mmol) were added to water (25 mL). The pH of the solution was adjusted to 8 by addition of either hydrogen peroxide or 0.1 M sodium hydroxide and the aqueous phase was added to the suspension polymerization solution xylenes (450 mL) and ethyl cellulose (0.9 g, 250-300 cp 5% in 80/20 toluene/ethanol) in a 1000 mL reaction bottom fitted with a reaction top and mechanical stirrer. Nitrogen was bubbled through the solution for 10 minutes before heating to 80° C. for 5 hours, while stirring at 235 rpm with a pivot paddle (shaft length 50 cm; 0.7 cm diameter; impeller is 5.0 cm wide). Upon completion of the polymerization, the mixture allowed to separate and cool. The supernatant was decanted and the beads were washed with acetone (200 mL), filtered, and washed with further acetone (3×250 mL). The beads were allowed to air dry overnight.

### EXAMPLE 14

Arsenate bead preparation by suspension polymerization, 25% crosslinked, 1% ligand/arsenate complex: Styrene (18.25 g, 175 mmol) and divinylbenzene (6.25 g, 48 mmol) were passed through activated alumina to remove their inhibitors to provide an organic solution. N-(4-vinylbenzyl)-N-dodecyl-N-methylglucammonium hydrogenarsenate (0.25 g, 0.05 g/mL xylenes), AIBN (0.25 g), and dodecanethiol (1.25 g, 6.2 mmol) were added to toluene (20 mL) and added to the organic solution. The organic solution was added to a suspension polymerization solution consisting of 2% PVOH/boric acid/water (450 mL) in a 1000 mL reaction bottom fitted with a reaction top and mechanical stirrer. Nitrogen was bubbled through the solution for 10 minutes before heating to 80° C. for 5 hours, while stirring at 300 rpm with a pivot paddle (shaft length 50 cm; 0.7 cm diameter; impeller is 5.0 cm wide). Upon completion of the polymerization, the mixture allowed to separate and cool. The mixture was added to a 1 L separatory funnel and allowed to separate into phases. A 100 mL aliquot was taken for ICP-OES analysis. ICP showed that 7.5 mg of arsenic was found in the liquor out of an estimated 10 mg. The beads were filtered, washed with water (2×100 mL), methanol (2×100 mL), acetone (2×100 mL) and ether (100 mL) before vacuum drying. The dry weight of the beads was 13 g (52%).

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A molecularly imprinted polymer sensor device for detecting a specific inorganic target ion comprising a molecularly imprinted polymer bead comprising a macroporous structure having a plurality of complexing cavities therein, wherein the complexing cavities contain cationic ligands spatially oriented to selectively receive and bind a specific inorganic target ion to be detected and having operatively associated therewith a light source for generating excitation energy for the porous structure; and a detector for detecting luminescent energy generated by the porous structure upon excitation.

2. The sensor device of claim 1, wherein the light source is selected from the group consisting of an argon laser, blue laser, tunable laser, light emitting diode, and combinations of two or more thereof.

3. The sensor device of claim 1, wherein the light source is a light emitting diode.

4. The sensor device of claim 1, wherein the detector is selected from the group consisting of a spectrophotometer, spectrometer, photomultiplier tube, monochromator equipped with a CCD camera, filters, the naked eye, and combinations of two or more thereof.

5. The sensor device of claim 1, wherein the bead contains different complexing cavities for binding different target compounds.

6. The sensor device of claim 1, wherein the cationic ligand is selected from the group consisting of cationic oxygen containing heterocyclics, cationic nitrogen containing heterocyclics, cationic sulfur containing heterocyclics, cationic phosphorous containing heterocyclics, ammonium salts, phosphonium salts, acylinium salts, metallocenium salts, amidinium salts, imminium salts, trityl salts, and mixtures thereof.

7. The sensor device of claim 1, wherein the target compound is arsenate, arsenite, nitrate, nitrite, cyanide, dicyanoaurate and/or dicyanoargentate.

8. The sensor device of claim 1, wherein the bead has a diameter of about 50 microns to 1.5 mm.

9. The sensor device of claim 1, wherein the bead has a diameter of about 300 microns to about 1000 microns.

10. The sensor device of claim 7, wherein the light source is a light emitting diode.

11. A method for detecting a target analyte comprising providing a fluid comprising an analyte to be detected and contacting the solution with a molecularly imprinted polymer sensor device comprising a molecularly imprinted polymer bead comprising a macroporous structure having a plurality of complexing cavities therein, wherein the complexing cavities contain cationic ligands spatially oriented to selectively receive and bind a specific inorganic target ion to be detected and having operatively associated therewith a light source for generating excitation energy for the porous structure; and a detector for detecting luminescent energy generated by the porous structure upon excitation.

12. The method of claim 11, wherein the fluid is an aqueous medium.

13. The method of claim 11, wherein the light source is selected from the group consisting of an argon laser, blue laser, tunable laser, light emitting diode, and combinations of two or more thereof.

14. The method of claim 11, wherein the light source is a light emitting diode.

15. The method of claim 11, wherein the detector is selected from the group consisting of a spectrophotometer, spectrometer, photomultiplier tube, monochromator equipped with a CCD camera, filters, the naked eye, and combinations of two or more thereof.

16. The method of claim 11, wherein the bead contains different complexing cavities for binding different target compounds.

17. The method of claim 11, wherein the cationic ligand is selected from the group consisting of cationic oxygen containing heterocyclics, cationic nitrogen containing heterocyclics, cationic sulfur containing heterocyclics, cationic phosphorous containing heterocyclics, ammonium salts, phosphonium salts, acylinium salts, metallocenium salts, amidinium salts, imminium salts, trityl salts, and mixtures thereof.

18. The method of claim 11, wherein the target compound is arsenate, arsenite, nitrate, nitrite, cyanide, dicyanoaurate, or dicyanoargentate.

19. The method of claim 11, wherein the bead has a diameter of about 50 microns to 1.5 mm.

20. The method of claim 11, wherein the sensor device is portable.

21. A molecularly imprinted polymer sensor device for detecting a specific inorganic target ion comprising a housing comprising (i) an inlet and an outlet to receive a flow of fluid, (ii) a cavity comprising a plurality of molecularly imprinted polymer beads comprising a macroporous structure having a plurality of complexing cavities therein, wherein the complexing cavities contain cationic ligands spatially oriented to selectively receive and bind a specific inorganic target ion to be detected from the flow of the fluid; (iii) a light source for generating excitation energy from the beads; and (iv) a window configured to allow viewing of the luminescent energy generated by the beads from external to the housing and determine when the amount of target ions in the beads exceeds a predetermined level.

22. The sensor device of claim 21, further comprising a power source for generating electricity coupled to the light source.

23. The sensor device of claim 21, wherein the light source is a light emitting diode.

24. The sensor device of claim 21, wherein the fluid is water.

25. The sensor device of claim 21, wherein the cationic ligand is selected from the group consisting of cationic oxygen containing heterocyclics, cationic nitrogen containing heterocyclics, cationic sulfur containing heterocyclics, cationic phosphorous containing heterocyclics, ammonium salts, phosphonium salts, acylinium salts, metallocenium salts, amidinium salts, imminium salts, trityl salts, and mixtures thereof and the target compound is arsenate, arsenite, nitrate, nitrite, cyanide, dicyanoaurate, and/or dicyanoargentate.
